(19) United States
(12) Patent Application Publication
(10) Pub. No.: US 2010/0206771 A1
(43) Pub. Date: Aug. 19, 2010

(54) PROCESS AND PLANT FOR PRODUCING HYDROCARBONS

(75) Inventors: Martin Rothaemel, Frankfurt am Main (DE); Harald Kömpel, Neu-Isenburg (DE); H. Bach, Heiligenroth (DE); W. Liebner, Oberursel (DE)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: Lurgi GmbH, Frankfurt am Main (DE)

(21) Appl. No.: 12/678,566

(22) PCT Filed: Sep. 6, 2008
(86) PCT No.: PCT/EP08/07299

§ 371 Date: Mar. 17, 2010

(30) Foreign Application Priority Data
Sep. 21, 2007 (DE) 10 2007 045 238.3

(51) Int. Cl. C10G 57/00; B01J 8/04; B01J 8/06

(52) U.S. Cl. 208/70; 422/189; 422/190

(57) ABSTRACT

For the production of hydrocarbons, in particular C₂-C₄ olefins, using a combined plant with a steam cracker and at least one reactor for converting an educt mixture which includes steam and at least one oxygenate, the respective intermediate product streams of the steam cracker and of the reactor are at least partly combined. To increase the yield of valuable products, a shape-selective zeolite material is used as catalyst in the reactor for oxygenate conversion and at least a part of the product streams obtained downstream of the combined plant is recirculated to the steam cracker and/or the reactor.

### CROSS-REFERENCE TO RELATED APPLICATIONS

This application is a national stage application under 35 U.S.C. 371 of International Patent Application Serial No. PCT/EP2008/007299, entitled “Verfahren and Anlage zur Herstellung von Kohlenwasserstoffen,” filed Sep. 6, 2008, which claims priority from German Patent Application No. 10 2007 045 238.3, filed Sep. 21, 2007.

### FIELD OF THE INVENTION

The present invention relates to a process for producing hydrocarbons, in particular C₂-C₄ olefins, by using a combined plant with a steam cracker and at least one reactor for converting an educt mixture which includes steam and at least one oxygenate, wherein the respective intermediate product streams of the steam cracker and of the reactor are at least partly combined. Furthermore, the present invention relates to a plant suitable for performing the process.

### BACKGROUND OF THE INVENTION

There is a worldwide increase in the demand for low-molecular C₂-C₄ olefins, such as ethylene and propylene. In steam cracking, predominantly saturated long-chain hydrocarbons are converted to short-chain hydrocarbons in the presence of steam. In this process olefins, methane and pyrolysis gasoline are obtained above all. While ethylene can be produced at low cost by steam crackers and in particular by ethane crackers, the likewise recoverable amount of propylene is greatly limited.

Beside the recovery of low-molecular C₂-C₄ olefins by steam cracking, processes for converting oxygenates to olefins (OTO process) are also known to those skilled in the art. The conversion of methanol to propylene (MTP-process) likewise belongs in this group. DE 100 27 159 A1, for instance, describes an MTP process in which a steam mixture containing dimethyl ether initially is produced from methanol vapor by a first catalyst, before the same is mixed with steam and converted to a product mixture containing propylene in at least two series-connected fixed-bed reactors with catalyst beds of shape-selective zeolite. Subsequently, the product mixture is processed in a separating means comprising a plurality of distillation columns, wherein a fraction rich in propylene with a propylene content of at least 95 vol-%, a fraction containing low-molecular hydrocarbons which is recirculated to the catalyst bed, and a fraction rich in gasoline hydrocarbons which is removed from the process, is obtained. What is, however, disadvantageous in this process is the low yield of propylene, based on the total carbon content in the educt mixture.

While the conversion of oxygenate and the process of steam cracking generally were performed in separate plants, US 2005/0038304 A1 describes the integrated use of a steam cracker together with a plant for converting an oxygenate (OTO reactor), such as methanol (MTO conversion), to an olefin. It is provided that the product streams leaving the steam cracker and the OTO reactor are combined completely or at least partly in the case of a preceding separation. Such integration of an OTO reactor with a steam cracker as a combined plant provides for the reduction of the total investment costs, because the processing sections of both parts are almost identical. In the OTO reactor, silicoaluminophosphate (SAPO) catalysts are provided in the form of molecular sieves, due to their claimed high selectivity for the formation of ethylene and propylene. The fluidized-bed reactor filled with a SAPO bed constitutes an isothermal reactor, so that the utilization of the reaction heat of the two processes integrated in the combined plant only is possible to a limited extent.

### SUMMARY OF THE INVENTION

Against this background, it is the object of the present invention to increase the yield of valuable products such as propylene. In addition, saving of energy should be achieved.

The present invention achieves this objective using the following approach:

for the conversion of oxygenate a shape-selective zeolite material is used in the reactor, and

at least a part of the product streams obtained downstream of the combined plant is recirculated to the steam cracker and/or the reactor.

As clarification it should be noted that the term “intermediate product stream” in accordance with the invention designates the liquid or gas stream which leaves the steam cracker or the reactor for oxygenate conversion. The so-called intermediate product streams can be combined either immediately, i.e. before quenching, or thereafter. The term “product stream”, on the other hand, designates those liquid or gas streams which leave the combined plant and represent either end products, such as ethylene or propylene, or product streams provided for recirculation, such as methane. In “shape-selective” zeolite catalysts, the system of pore channels of the zeolites used is characterized by defined pore openings.

A prerequisite for the practicability of the present invention is the use of such shape-selective zeolite catalyst, which can convert heavy hydrocarbons to ethylene and propylene. In the case of the recirculation of in particular longer-chain C₄ products from the steam cracking process, the SAPO catalyst used in US 2005/0038304 A1 on the other hand leads to an increased formation of undesired carbonaceous deposits (so-called coke deposits).

In the case of the present invention, the use of shape-selective zeolite catalysts being different from SAPO catalysts and the use of adiabatic fixed-bed reactors instead of isothermal fluidized-bed reactors additionally opens up the possibility of heat integration between the strongly endothermal steam cracking and the exothermal MTP reaction.

The conversion of the “waste streams” in accordance with the invention has another advantage specific for the MTP reactor: Due to the endothermal conversion of the C₄ olefins to propylene and the additional thermal capacity of the paraffins, the temperature profile in the MTP reactor can be raised and the propylene selectivity thus can be increased. The propylene yield additionally is increased by using the recirculated C₄ olefins as an additional propylene source. In a combined plant, as compared to two separate plants, this leads to an increase in both yield and product value. In general, this leads to an advantageous change of the product spectrum of the combined plant, which substantially only produces the three main products ethylene, propylene and gasoline. The purge streams furthermore obtained comprise “light ends” (volatile hydrocarbons, which are lighter than propane), LPG and non-specified heavy hydrocarbons (“heavies”). Nevertheless, the total amount of the by-product streams, such as the C₄ mix and the pyrolysis gasoline, is reduced. In general, an improved economic efficiency is obtained thereby. By means of the process of the invention, the C₂₌/C₃₌ ratio can selectively be changed between 25 and 100%.

By combining an ethane cracker, which actually tends to produce less gasoline, with an MTP reactor, an increase of the gasoline fraction in the total product can also be achieved.

Preferably, the oxygenates for producing propylene consist of methanol and/or dimethyl ether. Beside the MTP conversion, other oxygenates than methanol can be used in principle in accordance with the invention. In principle, the feed can also consist of a mixture of several oxygenates.

Applying the process of the invention, all zeolite catalysts suitable for converting methanol and/or dimethyl ether to C₂-C₄ olefins can be used in principle, wherein alumosilicate zeolites of the pentasil type are particularly preferred. The catalyst of the pentasil type ZSM-5 is preferred.

It is within the scope of the invention that after being separated, the individual product streams of the combined plant are supplied to the steam cracker and/or the reactor (OTO reactor or MTP reactor). For this purpose, the recirculation of various product streams is provided. The product stream substantially consisting of methane and/or “light ends” preferably is recirculated to the reactor for oxygenate conversion. On the other hand, the product stream substantially consisting of ethane and/or propane can be supplied to the steam cracker. The product stream substantially consisting of the C₄ cut and/or the C₄₌ cut likewise can again be supplied to the reactor for oxygenate conversion. In accordance with the invention, the same is true for the product stream substantially consisting of C₅ cut and/or C₆ cut. It is an obvious feature that the recirculation proceeds during the normal operation of the combined plant and that all different recycle streams can be controlled independently. In addition, the recirculation can each be done in a continuous and/or a discontinuous manner.

This invention also relates to a plant which is suitable for performing the process of the invention and includes a steam cracker and at least one catalytic reactor for converting an educt mixture, which includes steam and at least one oxygenate, into a reaction mixture comprising low-molecular olefins and gasoline hydrocarbons, wherein the respective intermediate product streams are at least partly combined. At least one separating means is provided for separating the product mixture obtained after combining the intermediate product streams. In accordance with the invention, the reactor includes a shape-selective zeolite material as catalyst, and the separating means are connected with the steam cracker and/or the reactor via recycle conduits, so that at least a part of the product streams obtained downstream of the combined plant can be recirculated.

In this combined plant, the reactor for oxygenate conversion preferably is integrated in the steam cracker.

The reactor for oxygenate conversion preferably is a fixed-bed reactor or a tubular reactor. The configuration as fluidized-bed reactor is not completely excluded, but it is not preferred for the reasons stated above. If the reactor is a tubular reactor, a plurality of axially arranged tubes preferably are provided, which for instance have a length between 1 and 5 m and an inside diameter of 20 to 50 mm.

In accordance with a particular embodiment of the present invention, two or more reactors connected in series can also be used, in order to achieve a high conversion of the educt mixture. For this embodiment, in particular more than two series-connected fixed-bed reactors, each filled with a shape-selective zeolite catalyst, were found to be particularly useful. In this case a part of the educt mixture from the pre-reactor is routed to the first fixed-bed reactor. To each further fixed-bed reactor the product mixture of the fixed-bed reactor upstream together with a partial stream of the educt mixture from the pre-reactor is routed. By this embodiment, particularly good degrees of conversion are obtained. Equally good degrees of conversion are obtained when as an alternative to the aforementioned embodiment the educt mixture is passed through only one reactor, in which at least two series-connected catalyst stages are provided. In this case, the individual catalyst stages preferably are arranged one below the other and the educt mixture flows from the top to the bottom. Here as well, the educt mixture from the pre-reactor is distributed among the individual catalyst stages.

### BRIEF DESCRIPTION OF THE FIGURES

Developments, advantages and possible applications of the invention can also be taken from the following description of an embodiment and the drawing. All features described and/or illustrated form the subject-matter of the invention per se or in any combination, independent of their inclusion in the claims or their back-reference.

The drawings depict:

FIG. 1 schematic of an MTP reactor with a steam cracker, and

FIG. 2 a simplified diagram of the separation section of the combined plant consisting of an ethane cracker and an MTP reactor after combining the intermediate product streams.

### DETAILED DESCRIPTION

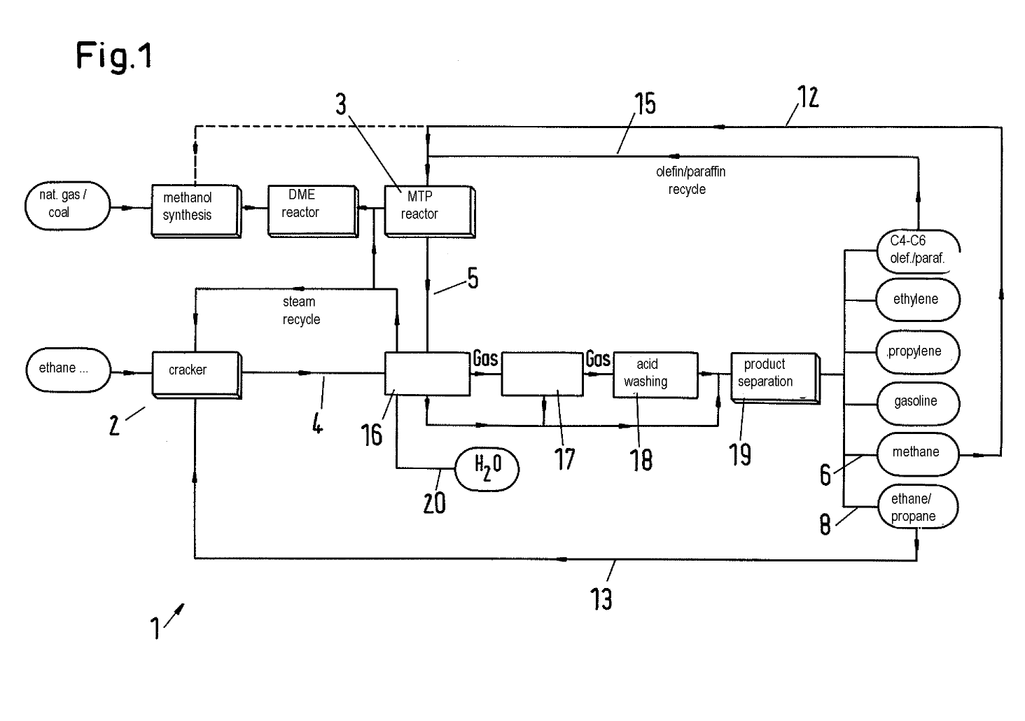

In the combined plant 1 as schematically shown in FIG. 1 a steam cracker 2 for converting ethane (ethane cracker) is combined with a reactor 3 for oxygenate conversion, in particular an MTP reactor.

Since both processes (steam cracking and MTP conversion) have a very similar product spectrum, the necessary processing of each of the product streams 4, 5 leaving the two parts of the plant largely is identical. This means that the plants and separating sections required for the further processing of the product streams can be combined in the case of the combined plant 1.

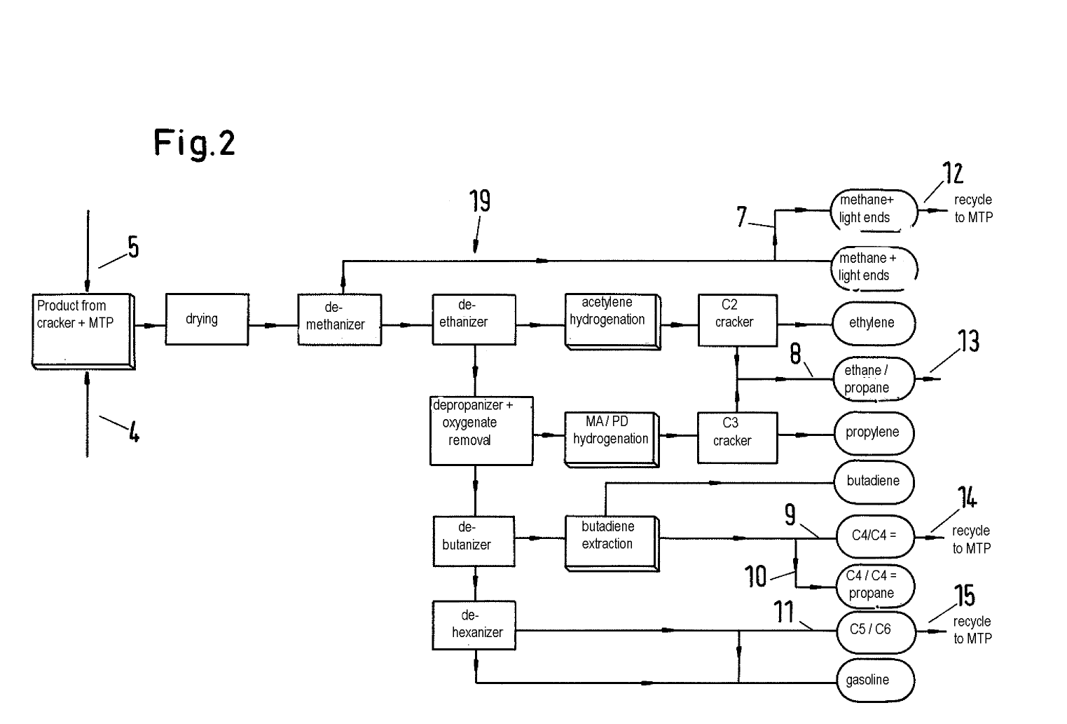

In the example shown in FIG. 1, the intermediate product streams 4, 5 leaving the steam cracker 2 and the MTP reactor 3 are supplied to a common water quenching stage 16. Upon condensation in a condenser 17, the gas stream is subjected to an acid washing 18 and then supplied to a separating stage 19, in which the gas mixture is divided into various product streams. The separating stage will be explained in detail below with reference to FIG. 2. In the example shown in FIG. 1, the product stream 6 consisting of methane is recirculated to the MTP reactor 3 via the return conduit 12. On the other hand, the product stream 8 consisting of propane and/or ethane is recirculated to the steam cracker 2 via the return conduit 13.

FIG. 2 is a simplified representation of the separation of the combined intermediate product streams 4, 5 from the ethane cracker 2 and the MTP reactor 3 of the combined plant 1. Upon drying, the intermediate product streams 4, 5 supplied from the cracker 2 and the MTP reactor 3 are routed to various series-connected separating stages, e.g. distillation columns, in order to obtain the product streams 7 to 11, possibly by further processing by hydrogenation or extraction. In addition, a stream 20 largely consisting of water is discharged as product from the water quenching stage 16.

Upon separation, the product streams 7 to 11 are recirculated to the MTP reactor 3 or the cracker 2 via return conduits 12 to 15. It is also possible that the C₄ product stream is both withdrawn through conduit 15 as end product (stream 9) and partly recirculated as stream 10 to the MTP reactor 3 through the return conduit 12. The same is true for the product streams consisting of methane and/or light ends.

### Example

The product distribution when using a cracker or a plant in accordance with the invention can be calculated on the basis of published results for the product spectrum of a cracker and the process data of the MTP process. For this calculation also the recirculation of various streams analogous to FIG. 2 and the resulting effects on product yields was considered. This includes the degrees of conversion and the selectivities of the various components (ethane and propane in the cracker, C₄-C₆ olefins in the MTP reactor). The cracker alone was assumed to have a typical world-scale capacity of about 800.000 t/a of ethylene. For the MTP reactor, an upstream mega methanol plant (cf. EP 0 790 226 B1) with a capacity of 5000 t/d of methanol was assumed. The purge rates of the recycle streams were adapted such that realistic ratios between feed and recycle quantities are obtained (C₂ purge 5%, C₄ purge 5%, C₅ purge 20%).

The results of the integration are listed in the following table, which compares the respective production figures for a pure ethane cracker with those from the combined plant described here.

TABLE 1

| | MTP + | Only | |
|---|---|---|---|
| | cracker | Cracker | |
| | t/a | t/a | increase |
| Feedstock | | | |
| Ethane | 1.020.385 | 1.020.385 | |
| MeOH | 1.660.000 | | |
| Sum | 2.680.385 | 1.020.385 | |
| Products | | | |
| Ethylene | 854.579 | 803.680 | 6% |
| Propylene | 458.994 | 18.663 | 2359% |
| Light ends | 157.949 | 153.432 | 3% |
| LPG | 28.016 | 8.977 | 212% |
| Butadiene | 28.577 | 28.577 | |
| Gasoline | 180.926 | 13.507 | 1240% |
| Heavies | 37.594 | 2.855 | 1217% |
| Sum HC | 1.746.635 | 1.029.690 | |
| Water | 933.750 | | |
| Total sum | 2.680.385 | 1.029.690 | |
| C₂₌/C₃₌ | 1.86 | 43.06 | |
| | 1.551.092 | 873.403 | |
| % valuable products | 88.8% | 84.8% | |

These data include the conversion and utilization of various product streams from one part of the plant in the respective other part, in particular the recirculation of butadiene-free C₄ cut and the C₅/C₆ cut from the steam cracker into the MTP reactor or the conversion of the propane obtained in the MTP reactor in the steam cracker. In the respective reactors, both reactions mainly provide ethylene and propylene.

By comparing the respective production figures, the advantages of the combined plant are obvious:

slight increase in the ethylene production (+6%)

significant increase in the propylene production (+2360%), partly due to the above-described synergies achievable with the invention

considerable improvement of the C₂₌/C₃₌ production ratio from 43 (only steam cracker) to 1.86 (combined plant)

significant increase in the gasoline product (+1240%), which also has a high quality (RON>93, benzene<1%)

hardly any change in the light ends (+3%)

more heavies (+1217%), which due to the high aromatics content should not be referred to as waste, but as a mixture usable for external processing

in general, a moderate increase of the fraction of valuable products in the total product from ˜85% to about 89%. The fact that the heavies stream also can be “valuable” is not yet considered here.

With the same capacity of the individual plants of the cracker and the MTP reactor, the present invention thus provides a combined plant with a surprisingly improved product spectrum.

### LIST OF REFERENCE NUMERALS

1 combined plant
2 steam cracker
3 reactor for oxygenate conversion (e.g. MTP reactor)
4 intermediate product stream from steam cracker
5 intermediate product stream from the reactor for oxygenate conversion
6 product stream of methane
7 product stream of methane and/or light ends
8 product stream of ethane and/or propane
9 product stream 1 of C₄ cut and/or C₄₌ cut
10 product stream 2 of C₄ cut and/or C₄₌ cut
11 product stream of C₅ cut and/or C₆ cut
12 return conduit for the product stream 7 of methane to the MTP reactor
13 return conduit for the product stream 8 of ethane and/or propane to the steam cracker
14 return conduit for the product stream 9 of C₄ cut and/or C₄₌ cut to the MTP reactor
15 return conduit for the product stream 11 of C₅ cut and/or C₆ cut to the MTP reactor
16 water quenching stage
17 condenser
18 acid washing
19 separating stage
20 product stream

1. A process for producing hydrocarbons, in particular C₂-C₄ olefins, by using a combined plant with a steam cracker and at least one reactor for converting an educt mixture which includes steam and at least one oxygenate, wherein the respective intermediate product streams of the steam cracker and of the reactor are at least partly combined, characterized in
that in the reactor a shape-selective zeolite material is used as catalyst, and
that at least a part of the product streams obtained downstream of the combined plant is recirculated to the steam cracker and/or the reactor.

2. The process according to claim 1, characterized in that the oxygenate consists of methanol and/or dimethyl ether.

3. The process according to claim 1, characterized in that the zeolite material consists of an alumosilicate zeolite of the pentasil type.

4. The process according to claim 3, characterized in that the zeolite material is of the pentasil type ZSM-5.

5. The process according to claim 1, characterized in that a product stream of the combined plant which substantially consists of methane and/or light ends is recirculated to the reactor.

6. The process according to claim 1, characterized in that a product stream of the combined plant which substantially consists of ethane and/or propane is recirculated to the steam cracker.

7. The process according to claim 1, characterized in that a product stream of the combined plant which substantially consists of C₄ cut and/or C₄₌ cut is recirculated to the reactor.

8. The process according to claim 1, characterized in that a product stream of the combined plant which substantially consists of C₅ cut and/or C₆ cut is recirculated to the reactor.

9. A plant for producing hydrocarbons, in particular C₂-C₄ olefins, with a steam cracker and at least one catalytic reactor for converting an educt mixture, which includes steam and at least one oxygenate, into a reaction mixture comprising low-molecular olefins and gasoline hydrocarbons, wherein the respective intermediate product streams are at least partly combined, and with at least one separating stage for separating the product mixture obtained after combining the intermediate product streams, characterized in
that the reactor includes a shape-selective zeolite material as catalyst, and
that the at least one separating stage is connected with the steam cracker and/or the reactor via at least one return conduit, through which at least a part of the product streams obtained downstream of the combined plant can be recirculated.

10. The plant according to claim 9, characterized in that the reactor for oxygenate conversion is integrated in the steam cracker.

11. The plant according to claim 9, characterized in that the at least one reactor constitutes a fixed-bed reactor or a tubular reactor.

12. The plant according to claim 11, characterized in that two or more reactors are connected in series or one reactor includes at least two series-connected catalyst stages.

13. The plant according to claim 9, characterized in that the catalyst in the reactor is an alumosilicate zeolite of the pentasil type, preferably ZSM-5.

14. The plant according to claim 9, characterized in that a return conduit for the product stream of the combined plant which substantially consists of methane and/or light ends is connected with the reactor.

15. The plant according to claim 9, characterized in that a return conduit for the product stream of the combined plant which substantially consists of ethane and/or propane is connected with the steam cracker.

16. The plant according to claim 9, characterized in that a return conduit for the product stream of the combined plant which substantially consists of C₄ cut and/or C₄₌ cut is connected with the reactor.

17. The plant according to claim 9, characterized in that a return conduit for the product stream of the combined plant which substantially consists of C₅ cut and/or C₆ cut is connected with the reactor.
